(19) United States
(12) Patent Application Publication
(10) Pub. No.: US 2018/0341696 A1
(43) Pub. Date: Nov. 29, 2018

(54) METHOD AND SYSTEM FOR DETECTING OVERLAPPING COMMUNITIES BASED ON SIMILARITY BETWEEN NODES IN SOCIAL NETWORK

(71) Applicant: Hefei University of Technology, Hefei (CN)

(72) Inventors: Shuai DING, Hefei (CN); Shanlin YANG, Hefei (CN); Xinbao LIU, Hefei (CN); Wenjuan FAN, Hefei (CN); Feng NIU, Hefei (CN); Hao WANG, Hefei (CN)

(21) Appl. No.: 15/892,279

(22) Filed: Feb. 8, 2018

(30) Foreign Application Priority Data
May 27, 2017 (CN) 201710393283.4

(51) Int. Cl. G06F 17/30

(52) U.S. Cl. CPC G06F 17/30604; G06F 17/30958; G06F 17/30867; G06F 17/30598

(57) ABSTRACT

The present disclosure discloses a method and system for detecting overlapping communities based on similarity between nodes in a social network. The method comprises steps of: receiving a social network to be detected; calculating a level of similarity between nodes in the social network to be detected; detecting overlapping communities in the social network based on the level of similarity between nodes; and, outputting a structure of the detected overlapping communities. In the method for detecting overlapping communities based on similarity between nodes in a social network of the present disclosure, a method for calculating similarity between network structure information and node attribute information is fused in the social network environment, and a method for discovering overlapping communities by fusing the similarity between nodes is proposed on this basis to obtain a high-quality community cohered in terms of both network structure and node preference.

### TECHNICAL FIELD

The present disclosure relates to the technical field of network data processing, and in particular to a method and system for detecting overlapping communities based on similarity between nodes in a social network.

### BACKGROUND

Majority of complex systems in the real world can be described by complex networks. For example, metabolic networks, protein interaction networks, gene networks, scientist co-author networks, power networks, aviation networks, social networks and the like. Complex networks have been always researched. In recent years, due to the rapid development of the Internet, people pay more and more attention to complex networks, particularly social networks, and lots of researches have been conducted.

Generally, due to the complicated internal structure of a complex network, it is very difficult to directly study the whole network. Therefore, it is general to study the community structure of the network so as to better understand the whole network. The community is a set of nodes. The nodes in a community are connected closely, but nodes in different communities are connected sparsely. The community structure commonly presents in a complex network. It has been proved that there is a community structure in a social network that is one kind of complex networks, and many community discovery algorithms used for complex networks can also be applied to the social network.

As the existing methods for handling the community discovery, there are mainly following three methods. One method is based on the node edge. That is, the community discovery is transformed into graph theory or other issues to be handled, by extracting edges between nodes in a network. In such a method, the attribute information and potential interest characteristics of nodes in the environment of the social network are not taken into consideration. Another method is based on the node content. By extracting the attribute information and potential characteristics of nodes in the network, the community discovery is transformed into node clustering or other issues to be handled. In such a method, the very important structural topology information in the network is ignored. There is also a comprehensive method in which the network structure is integrated with the node information and community discovery is performed in a same network respectively based on the network structure and the node information to obtain two different community structures. On this basis, the two communities are fused by some specific methods to eventually obtain a community that is cohered in terms of both the structure and the content. In such a method, community discovery is to be performed for two times. The efficiency of algorithms is low for a large-scale social network.

### SUMMARY

In view of the above problems, the present disclosure provides a method and system for detecting overlapping communities based on similarity between nodes in a social network, wherein a method for calculating similarity between network structure information and node attribute information is fused in the social network environment, and a method for discovering overlapping communities by fusing the similarity between nodes is proposed on this basis to obtain a high-quality community that is cohered in terms of both network structure and node preference.

To solve the above problems, the present disclosure provides a method for detecting overlapping communities based on similarity between nodes in a social network, specifically including steps of:

step S 1: receiving a social network to be detected;

step S2: calculating a level of similarity between nodes in the social network to be detected;

step S3: detecting overlapping communities in the social network based on the level of similarity between nodes; and

step S4: outputting a structure of the detected overlapping communities.

The calculating a level of similarity between nodes in the social network to be detected specifically includes steps of:

calculating social relationship similarity according to a neighbor node of a node to obtain social relationship similarity between nodes;

calculating attribute similarity according to an attribute of a node to obtain attribute similarity between nodes; and

obtaining the level of similarity between nodes in the social network according to the social relationship similarity and the attribute similarity between nodes.

The calculating attribute similarity according to an attribute of a node to obtain attribute similarity between nodes specifically includes steps of:

judging whether an attribute of a node is a discrete attribute or a text attribute;

when an attribute of a node is a discrete attribute, obtaining the attribute similarity between nodes by judging whether attributes of two nodes are equal, and determining that the attributes of the two nodes are similar if the attributes of the two nodes are equal;

when an attribute of a node is a text attribute, calculating attribute similarity between nodes specifically includes steps of:

inputting a text attribute value of a node;

performing word segmentation on an attribute text by character matching, and performing part-of-speech tagging on phrases obtained by the word segmentation;

removing stop words from the attribute text subjected to the word segmentation;

extracting keywords from the attribute text subjected to the removal of stop words to obtain keywords of nodes;

establishing a node-keyword matrix; and

calculating, as the attribute similarity between nodes, keyword similarity between nodes based on the node-keyword matrix.

The detecting overlapping communities in the social network based on the level of similarity between nodes specifically includes steps of:

calculating similar potential of each node in the social network according to the level of similarity between nodes, the similar potential of the node is the similarity impact of the node on node similarity;

setting a local high potential point for the social network according to the similar potential of each node, and using the local high potential point as an initial clustering center for rough clustering;

performing rough K Medoids clustering on nodes in the social network according to the initial clustering center for rough clustering to obtain an initial overlapping community structure of the social network;

optimizing the initial overlapping community structure by community merging; and

outputting an optimal overlapping community structure.

The setting a local high potential point for the social network according to the similar potential of each node and using the local high potential point as an initial clustering center for rough clustering specifically includes:

step S21: selecting any one unlabeled node vi from the social network and obtaining a set of neighbor nodes N(vᵢ), and calculating similar potentials of all nodes in the set of neighbor nodes;

step S22: proceeding to step S23 if ∀vⱼ∈N(vᵢ), p(vⱼ)≤p(vᵢ); if ∃vⱼ∈N(vᵢ), p(vⱼ)>p(vᵢ) and vⱼ has not yet been labeled, replacing vᵢ with vⱼ and then executing step S21 again, wherein vⱼ is a node in the set of neighbor nodes N(vᵢ);

step S23: labeling and then adding the node vᵢ to a set of initial clustering centers U;

step S24: executing step S21 if there are still nodes that have not yet been labeled in the social network; or otherwise, executing step S25; and

step S25: outputting the set of initial clustering centers U.

The performing rough K Medoids clustering on nodes in the social network according to the initial clustering center for rough clustering to obtain an initial overlapping community structure of the social network specifically includes:

step S31: setting an upper approximation weight wᵤₚ and a lower approximation weight w_{low} for rough clustering of a social network G(V,E);

step S32: if ∀vᵢ∈V,uⱼ ∈U, calculating p(vᵢ, uᵢ), where in p(vᵢ, uᵢ) is a similar potential generated by a central node ui at the node vᵢ;

step S3: classifying the node vᵢ to a strongest cluster Cₗ, and

p(vᵢ, Cₗ)=max {p(v₁, uᵢ), p(v₂, uᵢ), ⋅ ⋅ ⋅ , p(vᵢ, uᵢ)};

step S34: if ∀vᵢ ∈V, Cⱼ ∈C, calculating a potential difference ; δ=p(vᵢ, Cₗ)−p(vᵢ, Cⱼ) if δ≤α, classifying vᵢ to an intersection set of upper approximation sets of Cₗ and Cⱼ, that is, vᵢ ∈C̅ₗ∩C̅ⱼ or otherwise, classifying vi to a lower approximation set of Cₗ, that is, vᵢ ∈Cₗ;

step S35: for ∀Cₘ, Cₙ ∈C, if ∃vᵢ ∈(C̅ₘ̅−Cₘ)∩(C̅ₙ̅−Cₙ), that is, if the node vᵢ is located within a boundary region of two clusters, recalculating a potential of a node in a cluster, and setting p(vᵢ, Cₗ)=max {p(vᵢ, Cₘ), p(vᵢ, Cₙ)} and p(vᵢ, Cⱼ)=min {p(vᵢ, Cₘ), p(vᵢ, Cₙ)};

step S36: recalculating a clustering center;

step S37: when all clustering centers tend to be stable, executing step S38; or otherwise, returning to step S34; and

step S38: outputting the obtained clusters to obtain the initial overlapping community structure of the social network.

The optimizing the initial overlapping community structure by community merging specifically includes steps of:

step S41: setting community division C={C₁, C₂, ⋅ ⋅ ⋅ , Cₖ} of the social network and setting an overlap threshold Q;

step S42: selecting ∀Cₓ, C_{y} ∈ C, and calculating the overlap over (Cₓ, C_{y}); if over(Cₓ, C_{y})>Q, executing step S43; or otherwise, executing step S44;

step S43: merging C_{y} to Cₓ and updating the set C , and continuously executing step S42; and

step S44: when the overlap between any two of communities in the social network is less than Q, outputting the current community set C.

A method for calculating the overlap is as follows:

for two clusters Cᵢ and Cⱼ, the method for calculating the overlap of the two clusters is defined as follows:

$$Over ( {C}_{i} , {C}_{j} ) = \frac{\vert {C}_{i} ⋂ {C}_{j} \vert}{min \{ \vert {C}_{i} \vert , \vert {C}_{j} \vert \}}$$

where min{|Cᵢ|, |Cⱼ|} denotes the number of nodes in one of the clusters Cᵢ and Cⱼ having smallest nodes.

In another aspect of the present disclosure, a system for detecting overlapping communities based on similarity between nodes in a social network is provided, including:

a receiving unit configured to receive a social network to be detected;

a similarity calculation unit configured to calculate a level of similarity between nodes in the social network to be detected;

an overlapping community detection unit configured to detect overlapping communities in the social network based on the level of similarity between nodes; and

an output unit configured to a structure of the detected overlapping communities.

The similarity calculation unit specifically includes:

a social relationship similarity calculation subunit configured to calculate social relationship similarity according to a neighbor node of a node to obtain social relationship similarity between nodes;

an attribute similarity calculation subunit configured to calculate attribute similarity according to an attribute of a node to obtain attribute similarity between nodes; and

a similarity calculation subunit configured to obtain the level of similarity between nodes in the social network according to the social relationship similarity and the attribute similarity between nodes.

The method and system for detecting overlapping communities based on similarity between nodes in a social network of the present disclosure fully utilize the local topology information and the node information in the network. By the social relationship similarity and the attribute similarity, the relationship between nodes in the social network is roundly described.

In addition, in the present disclosure, by rough K Medoids clustering, the discovery of overlapping communities is completed simply and efficiently. Moreover, by adjusting related parameters in the clustering process, overlapping communities of different sizes can be obtained.

### BRIEF DESCRIPTION OF THE DRAWINGS

FIG. 1 is a flowchart of a method for detecting overlapping communities based on similarity between nodes in a social network according to the present disclosure;

FIGS. 2a-2c are schematic diagrams of a node-keyword bipartite network in this method;

FIG. 3 is a structural block diagram of a system for detecting overlapping communities based on similarity between nodes in a social network according to the present disclosure;

FIG. 4 is a comparison diagram of EQ values of first 15 largest communities obtained by an SLCDA algorithm and other two algorithms, according to an embodiment of the present disclosure; and

FIG. 5 is a comparison diagram of Average Preference Cohesion Exponents (APCEs) of first 15 largest communities obtained by an SLCDA algorithm and other two algorithms, according to an embodiment of the present disclosure.

### DETAILED DESCRIPTION OF THE DISCLOSURE

The specific implementations of the present disclosure will be further described in detail by embodiments with reference to the accompanying drawings. The following embodiments are used for describing the present disclosure and not intended to limit the scope of the present disclosure.

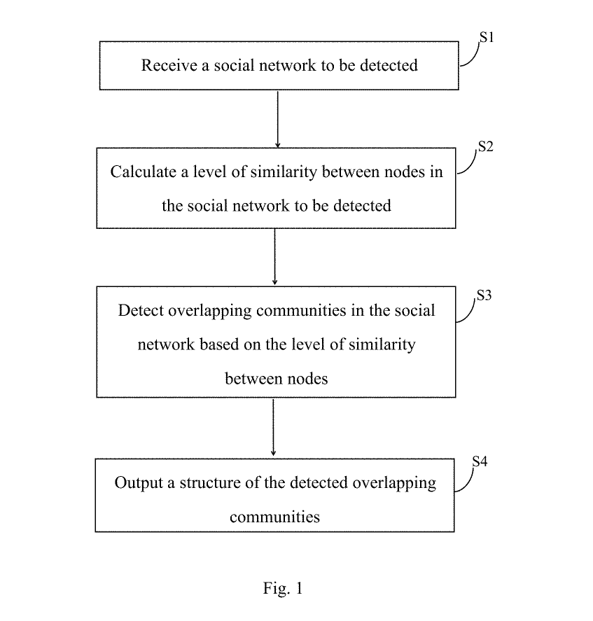

FIG. 1 shows a flowchart of a method for detecting overlapping communities based on similarity between nodes in a social network according to the present disclosure.

Referring to FIG. 1, the method for detecting overlapping communities based on similarity between nodes in a social network of the present disclosure specifically includes the following steps.

A method for detecting overlapping communities based on similarity between nodes in a social network is provided, including the following steps of:

receiving a social network to be detected;

calculating a level of similarity between nodes in the social network to be detected;

detecting overlapping communities in the social network based on the level of similarity between nodes; and

outputting a structure of the detected overlapping communities.

In an embodiment, the calculation of the similarity between nodes in the social network is performed in two dimensions, i.e., social relationship information and attribute information.

In the network G(V,E), for any node u, v ∈ V, the method for calculating the similarity between the node u and a node v is defined as follows:

S(u, v)=αS_S(u, v)+(1−α)S_A(u, v)

where S(u, v) is the similarity between the nodes u and v, S_S(u, v) and S_A(u, v) are the social relationship similarity and attribute similarity between the nodes u and v, respectively, and α is the weight of the two similarities.

The related concepts and calculation methods in the whole similarity calculation process will be described below in detail by specific embodiments.

In the social network, for any two adjacent nodes, if the neighborhood overlap is larger, the level of similarity between the two nodes is higher. Therefore, in this embodiment, the social relationship similarity between nodes is measured by the neighborhood overlap of different nodes.

For the nodes u and v in the social network, if sets of neighbor nodes are marked by Γ(u) and Γ(v) and D(t) is the degree of a node t, the method for calculating the social relationship similarity is defined as follows:

$${S}_{\_} S ( u , v ) = \frac{{\sum }_{t ∈ Γ ( u ) ⋂ Γ ( v )} \frac{1}{D ( t )}}{\sqrt{{\sum }_{t ∈ Γ ( u )} \frac{1}{D ( t )}} \sqrt{{\sum }_{t ∈ Γ ( v )} \frac{1}{D ( t )}}} .$$

For the nodes u and v in the social network, the attribute similarity is obtained by weighting and accumulating the attribute similarities of the nodes u and v, and the calculation method is defined as follows:

$${S}_{\_} A ( u , v ) = \frac{1}{\vert M \vert} {\sum }_{m = 1}^{M} {S}_{a} ( u , v , {α}_{m} )$$

where |M| denotes the number of attributes.

The attributes of a node can be generally classified into two categories: discrete attributes and text attributes. For the attributes of different types, the calculation method is also different. For a discrete attribute, the basic idea of the calculation of the attribute similarity is to judge whether the current value of the attribute is equal. For the nodes u and V, when the values of the discrete attributes αₘ are value1 and value2, the method for calculating the similarity of attributes αₘ of the nodes u and v is as follows:

$${S}_{a} ( u , v , {α}_{m} ) = \{ \begin{matrix}1 & value 1 = value 2 \\ 0 & value 1 \neq value 2\end{matrix}$$

It is to be noted that the current calculation of the similarity between discrete attributes is a universal method. In practical applications, the universal method for calculating the similarity between discrete attributes needs to be adjusted according to the specific meanings of the discrete attributes. For non-structured text attributes, the calculation of the similarity between the attributes is as follows.

In the first step, values of two text attributes (including long texts or short texts) to be compared are input.

In the second step, based on a large-scale public dictionary, word segmentation is performed on an attribute text by character matching, and part-of-speech tagging is performed on phrases obtained by the word segmentation.

In the third step, phases except for nouns, verbs, adjectives and adverbs are removed from the result of the word segmentation so as to complete the removal of stop words.

In the fourth step, keywords are extracted from the attribute text by a TextRank algorithm.

In the fifth step, a node-keyword matrix is established.

In the sixth step, the keyword similarity between nodes is calculated based on the node-keyword matrix. It is to be noted that, when a node in a network has keyword information (for example, a node tag in the MicroBlog network), the second, third and fourth steps in the calculation process of the similarity between text attributes can be directly omitted.

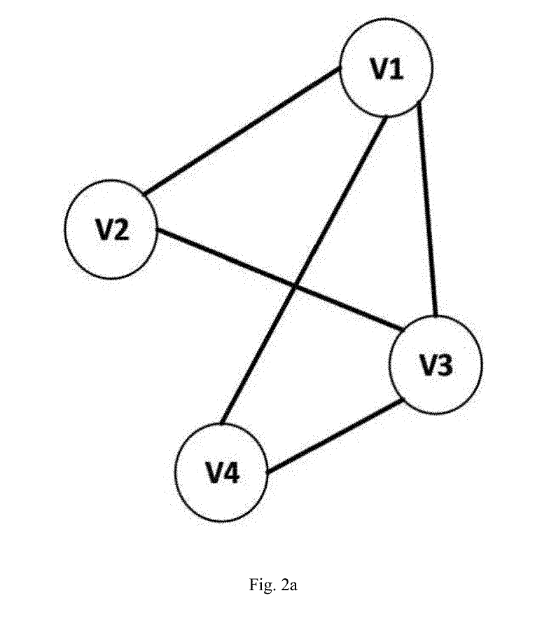

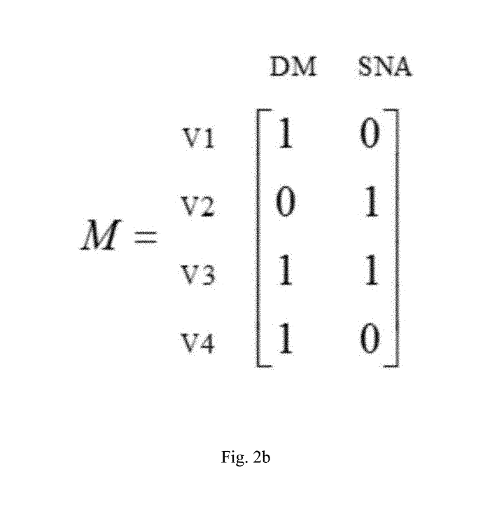

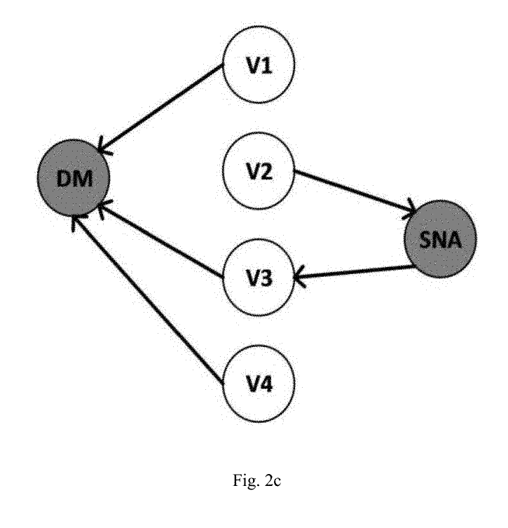

After the keyword information of all nodes has been extracted, an N×K node-keyword matrix M is established, where N is the number of nodes in the network, K is the number of extracted node keywords, and Mᵢⱼ=1 is the information about the j^{th} keyword of the i^{th} node. So far, in this embodiment, a bipartite network Gₖ has been established by nodes and corresponding keywords, wherein the nodes in the network include: user nodes of the original network and corresponding keyword nodes. When a user node has certain keyword information, a directed edge pointing from this user node to the keyword node is added. As shown in FIG. 2(a), the four nodes V1, V2, V3 and V4 form a basic network G, and the four nodes totally have two pieces of keyword information, i.e., DM and SNA. Subsequently, a node-keyword matrix M shown in FIG. 2(b) is established, and a node-keyword bipartite directed network Gₖ shown in FIG. 2(c) is obtained on this basis.

For the calculation of the similarity between nodes by using the keyword information, existing methods are to calculate the number of common keywords between two nodes. However, in the embodiments of the present disclosure, to better solve the community discovery problem in the social network, nodes in the network can be better distinguished by the keyword information of the nodes. Therefore, in the embodiments of the present disclosure, a corresponding weight is assigned to each keyword so as to distinguish different keywords for different people.

So far, in the network G, the node-keyword matrix M is obtained by a series of text processing operations, and the node-keyword bipartite network Gₖ is established on this basis. For two nodes u and v in the Gₖ, the similarity between text attributes αₘ is calculated as follows:

$${S}_{a} ( u , v , {α}_{m} ) = {\sum }_{k = 1}^{T} I ( {M}_{uk} = 1 ) \times I ( {M}_{vk} = 1 ) \times \frac{1}{lg {D}_{in} ( k )}$$

where Dᵢₙ(k) is the in-degree of the k^{th} keyword in the bipartite network Gₖ, meaning the number of nodes using the k^{th} keyword.

The specific process of detecting overlapping communities in the social network based on the similarity between nodes in the social network will be described below.

In the embodiments of the present disclosure, the method for detecting overlapping communities based on similarity between nodes in a social network is specifically a Similarity-Based Local Overlapping-Community Detection Algorithm (SLCDA).

The steps of the SLCDA algorithm will be described below.

First, the similarity between nodes in the network is calculated, and a similar potential of each node in the network is calculated on this basis. Then, a local high potential point for the network is obtained according to the similar potential of each node so as to determine an initial clustering center for rough clustering. Subsequently, other nodes in the network are classified to an upper approximation and a lower approximation of a cluster according to the similar potentials of the nodes, and a clustering center is reselected by calculating the upper approximation and the lower approximation of the cluster, until the clustering center remains unchanged, so that the rough K Medoids clustering is performed on the nodes in the network. Finally, clusters having a large overlap are continuously merged to obtain an optimal overlapping community structure.

This process will be specifically described below by specific embodiments.

In the social network, similar nodes tend to be associated with each other and the social network generally shows obvious local features, therefore the range of the similarity impact of each node in the network also has local characteristics. This range generally decreases with the increase of distance, decreases to 0 at a boundary of the similarity impact of the node. According to the characteristics of the similarity impact, it is proposed in this embodiment to describe the similarity impact of each node in the network by the similar potential and by a Gaussian potential function.

In a specific embodiment, for the network G(V,E), any node vᵢ ∈ V is selected as a field source, and an applied field U(vᵢ)={v₁, v₂, ⋅ ⋅ ⋅ , vₙ} is established by centering the node vᵢ. Then, the similar potential generated by the node vᵢ at the node vⱼ can be expressed by:

$$p ( {v}_{i} , {v}_{j} ) = {m}_{{v}_{j}} \times exp ( \frac{{S ( {v}_{j} , {v}_{i} )}^{2}}{2 {σ}^{2}} )$$

where mᵥ_{ⱼ} denotes the inherent attribute of the node vⱼ.

In practical applications, mᵥ_{ⱼ} is rich in physical significance, for example, the attribute characteristic of the node, the degree of activity and the like. In this embodiment, the inherent attribute of the node will be ignored. S(vⱼ, vᵢ) the similarity between the node vⱼ and the node vᵢ, and the range of the applied field of the node is controlled by the parameter σ. On this basis, the similar potential of the node vᵢ can be expressed by:

$$p ( {v}_{i} ) = {\sum }_{{v}_{j} ∈ U ( {v}_{i} )} exp ( \frac{{S ( {v}_{j} , {v}_{i} )}^{2}}{2 {σ}^{2}} )$$

Since the social network has obvious local characteristics, the community discovery based on the similar potential is essentially to discover a local high potential region by a representative node having a high similar potential in the network, so that the discovery of communities in the network is realized. Therefore, in this embodiment, the local high potential point in the social network is used as a clustering center for clustering.

In a specific embodiment, in the network G(V,E), there is a node vᵢ ∈ V and a neighbor node N(vᵢ)={v₁, v₂, ⋅ ⋅ ⋅ , vₙ}. The node vᵢ is a local high potential point in the current network if the node vi satisfies the following condition: p(vᵢ)≥max{p(v₁, v₁), p(v₁, v₂), ⋅ ⋅ ⋅ , p(vᵢ, vₙ)}.

In this embodiment, the specific steps of establishment of a set of initial clustering centers will be described below.

Step S21: Any one unlabeled node vᵢ is selected from the social network and a set of neighbor nodes N(vᵢ) is obtained, and similar potentials of all nodes in the set of neighbor nodes are calculated.

Step S22: If ∀vⱼ ∈ N(vᵢ), and p(vⱼ)≤p(vᵢ), step S23 will be executed; if ∃vⱼ ∈ N(vᵢ) and p(vⱼ)≥p(vᵢ) and vⱼ has not yet been labeled, vᵢ is replaced with vⱼ and then step S21 is executed again, wherein vⱼ is a node in the set of neighbor nodes N(vᵢ).

Step S23: The node vᵢ is labeled and then added to a set of initial clustering centers U.

Step S24: If there are still nodes that have not yet been labeled in the social network, step S21 will be executed; or otherwise, step S25 will be executed.

Step S25: The set of initial clustering centers U is output.

After an initial clustering center is selected, rough K Medoids clustering is performed on nodes in the social network to obtain an initial overlapping community structure of the social network.

In an embodiment, for a cluster Cᵢ, for any node uᵢ ∈Cᵢ, when uᵢ is a central node of the cluster Cᵢ, the similar compactness of the Cᵢ is calculated by the following formula:

$$CT ( {C}_{i} , {u}_{i} ) = \{ \begin{matrix}\begin{matrix}{w}_{low} {\sum }_{{v}_{i} ∈ \underline{{C}_{i}}} p ( {u}_{i} , {v}_{i} ) + \\ {w}_{up} {\sum }_{{v}_{i} ∈ \overline{{C}_{i}} - \underline{{C}_{i}}} p ( {u}_{i} , {v}_{i} )\end{matrix} & if \underline{{C}_{i}} \neq ∅ , \overline{{C}_{i}} - \underline{{C}_{i}} \neq ∅ \\ {\sum }_{{v}_{i} ∈ \underline{{C}_{i}}} p ( {u}_{i} , {v}_{i} ) & if \underline{{C}_{i}} \neq ∅ , \overline{{C}_{i}} - \underline{{C}_{i}} = ∅ \\ {\sum }_{{v}_{i} ∈ \overline{{C}_{i}} - \underline{{C}_{i}}} p ( {u}_{i} , {v}_{i} ) & if \underline{{C}_{i}} \neq ∅ , \overline{{C}_{i}} - \underline{{C}_{i}} \neq ∅\end{matrix}$$

where CT(Cᵢ, uᵢ) is the similar compactness of the cluster Cᵢ when uᵢ is a central node, and W_{low} and wᵤₚ are weights of nodes in a lower approximation set and an upper approximation set of the cluster Cᵢ and satisfy the following condition: w_{low}+wᵤₚ=1. On this basis, the formula for updating the cluster center is defined as follows:

$${u}_{i} = \{ u \vert u ∈ {C}_{i} ⋀ CT ( {C}_{i} , u ) = {max}_{x ∈ {C}_{i}} \{ CT ( {C}_{i} , x ) \} \}$$

The step of obtaining the initial overlapping community structure by rough K-Medoids clustering will be described below.

Step S31: An upper approximation weight wup and a lower approximation weight wlow for rough clustering of a social network G(V,E) are set.

Step S32: ∀vᵢ ∈V,uᵢ ∈U, p(vᵢ, uᵢ) is calculated, wherein p(vᵢ, uᵢ) is a similar potential generated by a central node uᵢ at the node Vᵢ.

Step S3: The node vᵢ is classified to a strongest cluster Cₗ, and

p(vᵢ, Cₗ)=max{p(v₁, uᵢ), p(v₂, uᵢ), ⋅ ⋅ ⋅ , p(vᵢ, uᵢ)}.

Step S34: If ∀vᵢ ∈V, Cⱼ ∈C, a potential difference δ=p(vᵢ, Cₗ)−p(vᵢ, Cⱼ) is calculated. If δ≤α, vᵢ is classified to an intersection set of upper approximation sets of Cᵢ and Cⱼ, that is, vᵢ ∈C̅ₗ̅∩C̅ⱼ̅ or otherwise, vᵢ is classified to a lower approximation set of Cₗ, that is, vᵢ ∈Cᵢ.

Step S35: If ∀Cₘ, Cₙ ∈C and if ∃vᵢ ∈(C̅ₘ̅−Cₘ)∩(C̅ₙ̅−Cₙ), that is, if the node vᵢ is located within a boundary region of two clusters, a potential of a node in a cluster is recalculated, and p(vᵢ, Cₗ)=max{p(vᵢ, Cₘ), p(vᵢ, Cₙ)} and p(vᵢ, Cⱼ)=min{p(vᵢ, Cₘ), p(vᵢ, Cₙ)} are set.

Step S36: A clustering center is recalculated.

Step S37: When all clustering centers tend to be stable, step S38 will be executed; or otherwise, step S34 is returned.

Step S38: The obtained clusters are output to obtain the initial overlapping community structure of the social network.

After the initial overlapping community network of the social network is obtained, the initial overlapping community structure is optimized by community merging.

By optimizing the initial overlapping community structure by community merging, it is advantageous to improve the modularity EQ of the community structure and thus obtain a clearer community hierarchical structure. Based on this, in this embodiment, measurement of the degree of overlap between different clusters by the cluster overlap is realized by cluster merging.

In a specific embodiment, for two clusters Cᵢ and Cⱼ, the method for calculating the overlap of the clusters is defined as follows:

$$Over ( {C}_{i} , {C}_{j} ) = \frac{\vert {C}_{i} ⋂ {C}_{j} \vert}{min \{ \vert {C}_{i} \vert , \vert {C}_{j} \vert \}}$$

where min{|Cᵢ|,|Cⱼ|} denotes the number of nodes in one of the clusters Cᵢ and Cⱼ having smallest nodes. The step of optimizing the overlapping community structure will be described below.

Step S41: Community division C={C₁, C₂, ⋅ ⋅ ⋅ , Cₖ} of the social network and an overlap threshold Q are set.

Step S42: ∀Cₓ, C_{y} ∈C is selected, and the overlap over (Cₓ, C_{y}) is calculated. If over(Cₓ, C_{y})>Q, step S43 will be executed; or otherwise, step S44 will be executed.

step S43: C_{y} is merged to Cₓ and the set C is updated, and step S42 is continuously executed.

Step S44: When the overlap between any two of communities in the social network is less than Q, the current community set C is output.

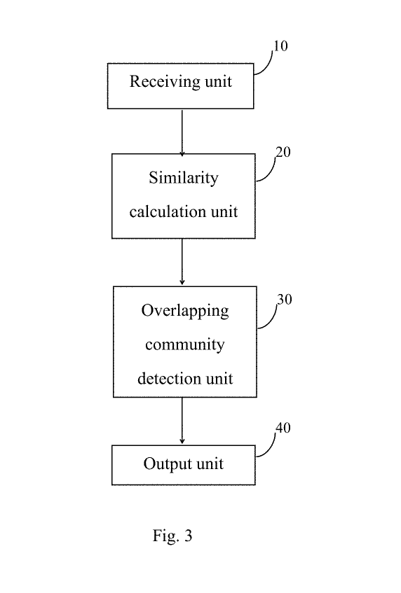

In another embodiment of the present disclosure, a system for detecting overlapping communities based on similarity between nodes in a social network is provided, as shown in FIG. 3, specifically including:

a receiving unit 10 configured to receive a social network to be detected;

a similarity calculation unit 20 configured to calculate a level of similarity between nodes in the social network to be detected;

an overlapping community detection unit 30 configured to detect overlapping communities in the social network based on the level of similarity between nodes; and

an output unit 40 configured to a structure of the detected overlapping communities.

In an embodiment, the similarity calculation unit 20 specifically includes:

a social relationship similarity calculation subunit 201 configured to calculate social relationship similarity according to a neighbor node of a node to obtain social relationship similarity between nodes;

an attribute similarity calculation subunit 202 configured to calculate attribute similarity according to an attribute of a node to obtain attribute similarity between nodes; and

a similarity calculation subunit 203 configured to obtain the level of similarity between nodes in the social network according to the social relationship similarity and the attribute similarity between nodes.

The method and system for detecting overlapping communities based on similarity between nodes in a social network of the present disclosure fully utilize the local topology information and the node information in the network, By the social relationship similarity and the attribute similarity, the relationship between nodes in the social network is roundly described.

In addition, in the present disclosure, by rough K Medoids clustering, the discovery of overlapping communities is completed simply and efficiently. Moreover, by adjusting related parameters in the clustering process, overlapping communities of different sizes can be obtained.

The method for detecting overlapping communities based on similarity between nodes in a social network of the present disclosure will be described below in detail by specific embodiments.

In the present disclosure, a user is represented by an ID of the user. A user having an ID of 1000080335 is selected, and data of microblog users is obtained according to the concern relation of this user by breadth traversal. The acquired information of microblog users includes: a list of relations (fans and concerns) of the user, personal attribute information of the user (user ID, nickname, location, gender, personal description and tag, and user type) and microblog information issued by the user (microblog ID, user ID, issue time and microblog content).

After the data processing has been completed, in this embodiment, a microblog network is established based on the concern relation between microblog users. The basic statistical information of the network is as follows: 5731 nodes, 46871 edges, an average node degree of 8.179, a network diameter of 9, and an average path length of 3.573.

For the evaluation of the structural cohesion, the extended modularity is selected as an evaluation index. For the network G(V,E) and |E|=m, and k communities are obtained after community discovery. For any node iÎ V, the node degree is dᵢ. If the number of communities to which the node vᵢ belongs is Oᵢ, the method for calculating the extended modularity is defined as follows:

$$EQ = \frac{1}{2 m} {\sum }_{k} {\sum }_{i , j} \frac{1}{{Q}_{i} {Q}_{j}} ( {A}_{ij} - \frac{{d}_{i} {d}_{j}}{2 m} )$$

where A_{i, j} is an adjacent matrix of the current network G. When there is an edge between a node i and a node j, the value of A_{i, j} is 1; or otherwise, the value of A_{i, j} is 0.

Expect the cohesion of the community structure, it is necessary to focus more on the preference similarity between nodes in the community. Therefore, it is proposed to describe the degree of preference cohesion by a preference cohesion exponent.

For a network G, if the result of community division is C={C₁, C₂, C₃, ⋅ ⋅ ⋅ Cₙ}, the method for calculating the preference cohesion exponent of the current community is defined as follows:

$$PCE = \frac{{\sum }_{i = 1}^{n} {\sum }_{u , v ∈ {C}_{i}} pref ( u , v )}{{\sum }_{u , v ∈ G} pref ( u , v )}$$

where PCE denotes the currently obtained preference cohesion exponent of a community and PCE ∈(0,1], pref(u,v) denotes the preference similarity between nodes u and v, and the numerator and the denominator denote the sum of preference similarities between node pairs in all communities and the sum of preference similarities between all node pairs in the whole network, respectively. The PCE merely reflects the overall degree of preference cohesion of all communities in a network, but it cannot really reflect the degree of preference cohesion of a particular community.

For a network G, if the result of community division is C={C₁, C₂, C₃, ⋅ ⋅ ⋅ Cₙ}, and any community Cᵢ ∈C is selected, the method for calculating the Average Preference Cohesion Exponent (APCE) of the community Cᵢ is defined as follows:

$$APCE = \frac{{\sum }_{u , v ∈ {C}_{i}} pref ( u , v )}{\vert {C}_{i} \vert}$$

where APCE denotes the average preference cohesion exponent of the current community, and |Cᵢ| is the number of nodes in the community Cᵢ. When the value of the APCE is larger, it is indicated that the current community has better confidence cohesion.

During the calculation of the attribute similarity confidence between nodes, in this embodiment, two attributes, i.e., numerical location information and text tag information, are selected. For the location attribute information, the rules for the similarity are as follows: if location attributes are identical in both the ID of province and the ID of city, the similarity between the location attributes is 1; if location attributes are identical in only the ID of province, not in the ID of city, the similarity between the location attributes is ⅔; and, if location attributes are different in both the ID of province and the ID of city, the similarity between the location attributes is 0. For the tag attribute information, by preprocessing the acquired microblog data, tag keyword data of users are obtained. Based on this, a user-tag bipartite network is established, and the similarity between tag attributes is calculated.

Two typical community discovery algorithms are selected for comparison, including Newman algorithm and Infomap algorithm. Table 1 shows the comparison of EQ values of the community structure obtained by the TLCDA algorithm and other two algorithms when the upper approximation weight wᵤₚ=0.1.

TABLE 1
Comparison of EQ values obtained by three algorithms
in the microblog network

| | | Number of | |
|---|---|---|---|
| Algorithm | Similarity Weight α | communities | Modularity EQ |
| SLCDA | 0 | 1527 | 0.077 |
| | 0.2 | 1453 | 0.149 |
| | 0.4 | 1305 | 0.208 |
| | 0.6 | 1347 | 0.171 |
| | 0.8 | 1259 | 0.243 |
| | 1.0 | 1211 | 0.277 |
| Newman | \ | 1929 | 0.341 |
| Infomap | \ | 2751 | 0.138 |

It can be known from Table 1 that the EQ values of the community structure obtained by the SLCDA algorithm are generally lower than that obtained by the Newman algorithm but higher than that obtained by the Infomap algorithm. Moreover, compared with the other two algorithms, the SLCDA algorithm can discover larger communities in the network.

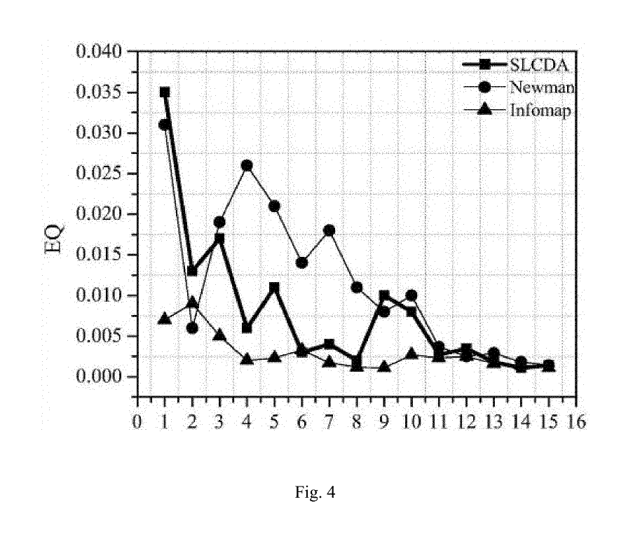

FIG. 4 shows the comparison of EQ values of first 15 largest communities obtained by the SLCDA algorithm and other two algorithms when the upper approximation weight and the social relationship similarity weight are 0.1 and 0.8, respectively, where the horizontal axis represents the first 15 largest communities obtained by the three algorithms and the vertical axis represents the evaluation exponent EQ of the cohesion of the community structure. It can be known that the modularity contribution value of the communities obtained by the TLCDA algorithm is significantly higher than that of the communities obtained by the Infomap algorithm.

By comparing and analyzing typical community discovery algorithms, it can be known that the communities obtained by the TLCDS algorithm substantially can meet the requirements on the structure cohesion.

In the researches on the personalized recommendation of e-commerce, the preference similarity between users is generally judged according to the nature or type of goods purchased by the users. In view of this, microblogs issued by users in the microblog network are regarded as the purchased “goods”, and the preference of users is judged according to the subject of the issued microblogs. Therefore, the preference similarity between users in the microblog network is defined.

In a microblog network G(V,E), for any two nodes vᵢ, vⱼ Î V, if sets of subject words of the issued microblogs are Tᵢ={t₁,t₂ ⋅ ⋅ ⋅ , tₘ} and Tᵢ={t₁,t₂ ⋅ ⋅ ⋅ , tₙ}, respectively, the method for calculating the preference similarity between the nodes vᵢ and vⱼ is defined as follows:

$$pref ( {v}_{i} , {v}_{j} ) = {\sum }_{{t}_{i} ∈ {T}_{i}} {\sum }_{{t}_{j} ∈ {T}_{j}} exp ( dis ( {t}_{i} , {t}_{j} ) )$$

wherein pref(vᵢ, vⱼ) is the preference similarity between the nodes vᵢ and vⱼ, dis(tᵢ,tⱼ) is a semantic distance between two microblog subject words, and exp(−dis(tᵢ,tⱼ)) is a function using e as a base number and a negative value of the sematic distance between the microblog subject words as an exponent.

Table 2 shows the comparison of PCE values of the community structure obtained by the SLCDA algorithm and other two algorithms when the upper approximation weight wᵤₚ=0.1. It can be known from Table 2 that the performance of the SLCDA algorithm in terms of preference cohesion is obviously better than that of other two algorithms.

TABLE 2
Comparison of PCE values obtained by the three algorithms
in the microblog network

| | | | Sum of | Preference | Modular- |
|---|---|---|---|---|---|
| | Weight | Number of | preference of | cohesion | ity |
| Algorithm | α | communities | communities | PCE | EQ |
| SLCDA | 0 | 1527 | 80531.0 | 0.249 | 0.077 |
| | 0.2 | 1453 | 85058.8 | 0.263 | 0.149 |
| | 0.4 | 1305 | 92497.4 | 0.286 | 0.208 |
| | 0.6 | 1347 | 82471.5 | 0.255 | 0.171 |
| | 0.8 | 1259 | 71475.3 | 0.221 | 0.243 |
| | 1.0 | 1211 | 64036.7 | 0.198 | 0.277 |
| Newman | \ | 1929 | 65006.9 | 0.201 | 0.341 |
| Infomap | \ | 2751 | 30401.3 | 0.094 | 0.138 |

Note:
the total preference of the current network is 323417.6

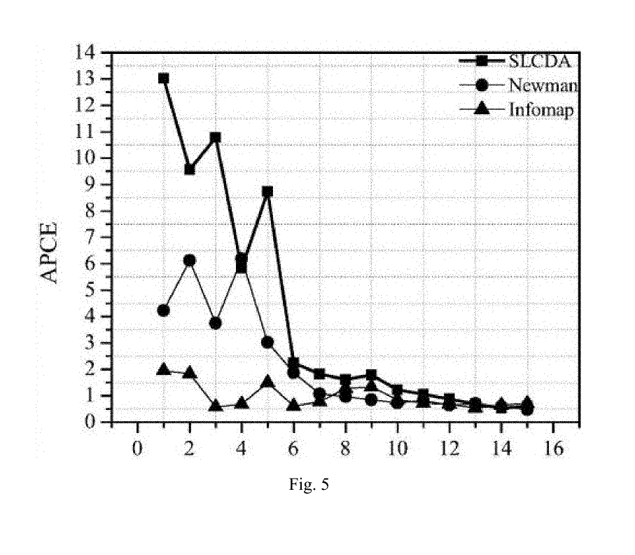

FIG. 5 shows the comparison of Average Preference Cohesion Exponents (APCEs) of first 15 largest communities obtained by the SLCDA algorithm and other two algorithms when the upper approximation weight and the social relationship similarity weight are 0.1 and 0.4, respectively, where the horizontal axis represents the first 15 largest communities obtained by three algorithms and the vertical axis represents the evaluation exponent APCE. It can be known that the performance of a single community obtained by the SLCDA algorithm in terms of APCE is better than that of other two algorithms.

Tests on the structure cohesion and the preference cohesion have indicated that the SLCDA algorithm fused with the node similarity provided herein can discover potential communities having a higher degree of preference cohesion, while meeting the requirements on the community structure cohesion.

The foregoing embodiments are merely used for describing the present disclosure and not intended to limit the present disclosure thereto. A person of ordinary skill in the related art can make various alterations and variations without departing from the spirit and scope of the present disclosure. Therefore, all equivalent technical solutions shall fall into the scope of the present disclosure, and the protection scope of the present disclosure shall be defined by the appended claims.

1. A method for detecting overlapping communities based on similarity between nodes in a social network, comprising steps of:
receiving a social network to be detected;
calculating a level of similarity between nodes in the social network to be detected;
detecting overlapping communities in the social network based on the level of similarity between nodes; and
outputting a structure of the detected overlapping communities;
wherein detecting overlapping communities in the social network based on the level of similarity between nodes specifically comprises steps of:
calculating similar potential of each node in the social network according to the level of similarity between nodes, the similar potential of the node is the similarity impact of the node on node similarity;
setting a local high potential point for the social network according to the similar potential of each node, and using the local high potential point as an initial clustering center for rough clustering;
performing rough K Medoids clustering on nodes in the social network according to the initial clustering center for rough clustering to obtain an initial overlapping community structure of the social network;
optimizing the initial overlapping community structure by community merging; and
outputting an optimal overlapping community structure.

2. The method according to claim 1, wherein calculating a level of similarity between nodes in the social network to be detected specifically comprises steps of:
calculating social relationship similarity according to a neighbor node of a node to obtain social relationship similarity between nodes;
calculating attribute similarity according to an attribute of a node to obtain attribute similarity between nodes; and
obtaining the level of similarity between nodes in the social network according to the social relationship similarity and the attribute similarity between nodes.

3. The method according to claim 2, wherein calculating attribute similarity according to an attribute of a node to obtain attribute similarity between nodes specifically comprises steps of:
judging whether an attribute of a node is a discrete attribute or a text attribute;
when an attribute of a node is a discrete attribute, obtaining the attribute similarity between nodes by judging whether attributes of two nodes are equal, and determining that the attributes of the two nodes are similar if the attributes of the two nodes are equal;
when an attribute of a node is a text attribute, calculating attribute similarity between nodes specifically comprises steps of:
inputting a text attribute value of a node;
performing word segmentation on an attribute text by character matching, and performing part-of-speech tagging on phrases obtained by the word segmentation;
removing stop words from the attribute text subjected to the word segmentation;
extracting keywords from the attribute text subjected to the removal of stop words to obtain keywords of nodes;
establishing a node-keyword matrix; and
calculating, as the attribute similarity between nodes, keyword similarity between nodes based on the node-keyword matrix.

4. The method according to claim 1, wherein setting a local high potential point for the social network according to the similar potential of each node and using the local high potential point as an initial clustering center for rough clustering specifically comprises:
step S21: selecting any one unlabeled node vᵢ from the social network and obtaining a set of neighbor nodes N(vᵢ), and calculating similar potentials p(vᵢ) of all nodes in the set of neighbor nodes;
step S22: proceeding to step S23 if ∀vⱼ ∈N(vᵢ) p(vⱼ)≤p(vᵢ); if ∃vⱼ ∈N(vᵢ) p(vⱼ)>p(vᵢ) and vⱼ has not yet been labeled, replacing vᵢ with vⱼ and then executing step S21 again, wherein vⱼ is a node in the set of neighbor nodes N(vᵢ), and;
step S23: labeling and then adding the node vᵢ to a set of initial clustering centers U;
step S24: executing step S21 if there are still nodes that have not yet been labeled in the social network; or otherwise, executing step S25; and
step S25: outputting the set of initial clustering centers U.

5. The method according to claim 1, wherein performing rough K-Medoids clustering on nodes in the social network according to the initial clustering center for rough clustering to obtain an initial overlapping community structure of the social network specifically comprises:
step S31: setting an upper approximation weight wᵤₚ and a lower approximation weight w_{low} for rough clustering of a social network G(V,E);
step S32: if ∀vᵢ ∈V,uᵢ ∈U, calculating p(vᵢ,uᵢ), wherein p(vᵢ,uᵢ) is a similar potential generated by a central node uᵢ at the node vᵢ;
step S3: classifying the node vᵢ to a strongest cluster Cₗ, and
p(vᵢ, Cₗ)=max{p(v₁,uᵢ), p(v₂,uᵢ), ⋅ ⋅ ⋅ , p(vᵢ,uᵢ)}
step S34: if ∀vᵢ ∈V, Cⱼ ∈C, calculating a potential difference δ=p(vᵢ, Cₗ)−p)vᵢ, Cⱼ); if δ≤α, classifying vᵢ to an intersection set of upper approximation sets of Cₗ and Cⱼ, that is, vᵢ ∈C̅ₗ̅∩C̅ⱼ̅; or otherwise, classifying vᵢ to a lower approximation set of Cₗ, that is, vᵢ ∈Cₗ;
step s35: if ∀Cₘ, Cₙ ∈C and if ∃vᵢ ∈(C̅ₘ̅−Cₘ)∩(C̅ₙ̅−Cₙ), that is, if the node vᵢ is located within a boundary region of two clusters, recalculating a potential of a node in a cluster, and setting p(vᵢ, Cₗ)=max{p(vᵢ, Cₘ), p(vᵢ, Cₙ)} and p(vᵢ, Cⱼ)=min{p(vᵢ, Cₘ), p(vᵢ, Cₙ)};
step S36: recalculating a clustering center;
step S37: when all clustering centers tend to be stable, executing step S38; or otherwise, returning to step S34; and
step S38: outputting the obtained clusters to obtain the initial overlapping community structure of the social network.

6. The method according to claim 1, wherein optimizing the initial overlapping community structure by community merging specifically comprises steps of:
step S41: setting community division C={C₁, C₂, ⋅ ⋅ ⋅ , Cₖ} of the social network and setting an overlap threshold Q;
step S42: selecting ∀Cₓ, C_{y} ∈C, and calculating the overlap over(Cₓ, C_{y}); if over(Cₓ, C_{y})>Q, executing step S43; or otherwise, executing step S44;
step S43: merging C_{y} to Cₓ and updating the set C, and continuously executing step S42; and
step S44: when the overlap between any two of communities in the social network is less than Q, outputting the current community set C.

7. The method according to claim 6, wherein a method for calculating the overlap is as follows:
for two clusters Cᵢ and Cⱼ, the method for calculating the overlap of the two clusters is defined as follows:
$$Over ( {C}_{i} , {C}_{j} ) = \frac{\vert {C}_{i} ⋂ {C}_{j} \vert}{min \{ \vert {C}_{i} \vert , \vert {C}_{j} \vert \}} ,$$
wherein min{|Cᵢ|,|Cⱼ|} denotes the number of nodes in one of the clusters Cᵢ and Cⱼ having smallest nodes.

8-9. (canceled)

10. The method according to claim 1, wherein for a node vᵢ, the similar potential p(vᵢ) of the node vᵢ is expressed by:
$$p ( {v}_{i} ) = {\sum }_{{v}_{j} ∈ U ( {v}_{i} )} exp ( \frac{{S ( {v}_{j} , {v}_{i} )}^{2}}{2 {σ}^{2}} ) ,$$
wherein S(vⱼ, vᵢ) is the similarity between the node vⱼ and the node vᵢ, and σ is a range of an applied field U(vᵢ) of the node vᵢ.
